(19) United States
(12) Patent Application Publication
(10) Pub. No.: US 2008/0183637 A1
(43) Pub. Date: Jul. 31, 2008

(54) Asset analysis system and method for doing the same

(76) Inventors: David O. Cramer, Woodward, OK (US); Timothy D. Cramer, Woodward, OK (US); Ronald J. McCance, Woodward, OK (US); Jerrod W. Tuck, Cypress, TX (US)

Correspondence Address: David O. Cramer, Rt. 3, Box 19, Woodward, OK, 73801, US

(21) Appl. No.: 11/699,612

(22) Filed: Jan. 30, 2007

(51) Int. Cl. G06Q 40/00

(52) U.S. Cl. 705/36 R

(57) ABSTRACT

A computer system for performing asset analysis on remote assets. More particularly, the computer system uses a methodology whereby an asset operating entity is able to electronically view the status of such assets as if the operating entity had personally attended to the asset.

### CROSS REFERENCE TO RELATED APPLICATIONS

Not Applicable.

### FIELD OF THE INVENTION

The presently claimed and disclosed invention(s) relate to asset analysis system. More particularly, the presently claimed and disclosed invention(s) use a methodology whereby an operator of assets, such as operated properties, is able to know and view the status of such assets without the need to be physically at the site of the asset. Such system is particularly useful for equipment inventory, governmental regulatory maintenance, environmental remediation, asset analysis, and the like.

### BACKGROUND OF THE ART

In order to inspect assets, such as operated properties that are remote from their operating entities, currently, the operating entities have to attend to such assets at the asset location or hire someone to attend to these assets. The operating entity attending to the assets personally is usually inconvenient, difficult, and time consuming. In addition, the analyses of such assets, such as the inspection of operated properties, require a level of expertise that most operating entities usually do not possess. If the operating entity chooses to hire a third party to attend to such assets, the third party is usually the only party that views the condition of such assets; thus, leaving the operating entity in a position that requires trusting a third party. Therefore, there is a need for a system that would allow the operating entity to retrieve the information relating to remote assets without the operating entity having to travel to the location of the assets, while at the same time, allowing the operating entity to view the status or condition of the remote assets.

Example of such assets is operated property and the like. Operated properties require regular maintenance and inspection. Most governments require that operated property comply with certain regulations. Moreover, the operating entity is required to always have periodic inspection documents completed with current information ready for submittal to governmental personnel at random times. Operated properties are usually located in remote locations. Traveling to such locations is usually difficult, costly, and time consuming. In addition, the inspections of the operated properties require knowledge of the regulations and experience in performing the operated properties' inspections. Therefore, most of the operating entities hire a field inspector for operated property analysis. As a result, the operating entities are usually removed from the process and are unable to personally view their operated properties condition, equipment, inventory deficiencies, pollution and imminent failure. Today, there is no solution to such problem.

This invention details a means to allow asset operating entities to perform asset analysis such that the above limitations are overcome.

### SUMMARY OF INVENTION

This invention allows operating entities to perform asset analysis for assets in remote locations. More particularly, this invention related to an operated property analysis sequence of instructions stored on at least one computer readable medium for running on a computer system. The instructions at least receive factual data, receive operated property status, and compare the factual data to the operated property status, and allow an operating entity to view data and analysis over the Internet as if viewing operated property at the location of the operated property. This invention also relates to the method of using, enhancing, and configuring the same.

### BRIEF DESCRIPTION OF THE SEVERAL VIEWS OF THE DRAWINGS

FIG. 1 is a schematic diagram of the hardware forming an exemplary embodiment of a computer system constructed in accordance with the present invention.

FIG. 2 is an illustration of an exemplary software/function flow chart of a method for performing asset analysis.

FIG. 3 is an illustration of an exemplary system diagram of a method for performing operated property analysis.

### DETAILED DESCRIPTION OF THE PRESENTLY DISCLOSED AND CLAIMED INVENTION

Before explaining at least one embodiment of the invention in detail, it is to be understood that the invention is not limited in its application to the details of construction, experiments, exemplary data, and/or the arrangement of the components set forth in the following description or illustrated in the drawings.

The invention is capable of other embodiments or of being practiced or carried out in various ways. Also, it is to be understood that the phraseology and terminology employed herein is for purpose of description and should not be regarded as limiting.

The presently claimed and disclosed invention(s) relate to asset analysis and methods for doing the same.

### DETAILED DESCRIPTION

It should be noted that the term “operating entity” referred herein is any person or entity that has ownership, control, or allowed control or access to the operation or monitoring of an operated property.

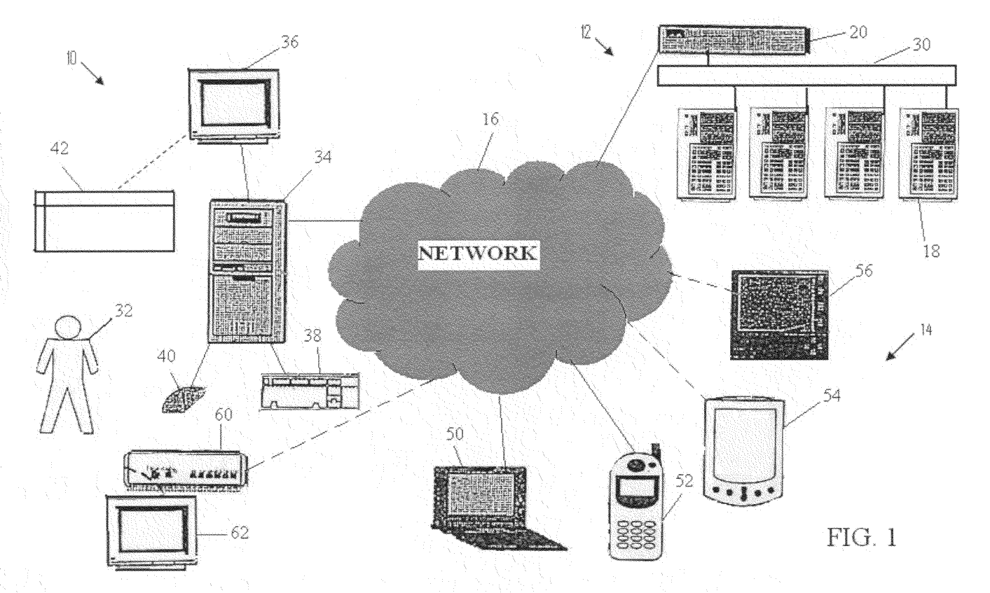

Referring now to the drawings and in particular to FIGS. 1, 2 and 3, shown therein and designated by a reference numeral 10 is an exemplary computer system constructed in accordance with the present invention.

Preferably, the computer system 10 is distributed, and includes a host system 12, communicating with one or more user devices 14 via a network 16. The network 16 can be the Internet or other network. In either case, the host system 12 typically includes one or more servers 18 configured to communicate with the network 16 via one or more gateways 20. When the network 16 is the Internet, the primary user interface of the computer system 10 is delivered through a series of web pages, but the primary user interface can be replaced by another type of interface, such as a Windows-based application. This method is also used when deploying the computer system 10 in a stand-alone environment such as a kiosk.

The network 16 can be any type of network although Internet and Internet 2 networks are preferred because of the wide support of their underlying technologies. The preferred embodiment of the network 16 exists in an Internet environment, which means a TCP/IP-based network. It is conceivable that in the near future, the preferred or other embodiments, may wish to use more advanced networking topologies.

The servers 20 can be networked with a LAN 30. The gateway 20 is an entity responsible for providing access between the LAN 30 and the network 16. The gateway 20 can also be used as a security means to protect the LAN 30 from attack from external networks such as the network 16.

The LAN 30 network can be based on a TCP/IP network such as the Internet, or it can be based on another underlying network transport technology. The preferred embodiment uses an Ethernet network with TCP/IP because of the availability and acceptance of underlying technologies, but other embodiments may use other types of networks such as Fibre Channel, SCSI, Gigabit Ethernet, etc.

As discussed above, in one preferred embodiment, the host system 12 includes the servers 18. The configuration of the server hardware will depend greatly upon the requirements and needs of the particular embodiment of the computer system 10. Typical embodiments, including the preferred embodiment, will include multiple servers 18 with load balancing to increase stability and availability. It is envisioned that the servers 18 will include database servers and application/web servers. The database servers are preferably separated from the application/web servers to improve availability and also to provide the database servers with improved hardware and storage.

The user devices 14 can be any number and type of devices. The most typical scenario of the user device 14 involves a user 32, using a computer 34 with a display 36, keyboard 38, and mouse 40. In the preferred embodiment, the user 32 is required to use a type of software called a “browser” as designated by a reference numeral 42. The browser 42 is used to render content that is received from a source. In the modern vernacular, a “browser” refers to a specific implementation called a Web Browser. Web Browsers are used to render HTML/XHTML content that is generated when requesting resources from a web server. In the preferred embodiment, the computer system 10 is designed to be compatible with major Web Browser vendors (Microsoft Internet Explorer, Netscape Navigator, and Opera). Other embodiments may wish to focus on one particular browser depending upon the common user base using the computer system 10.

The user devices 14 can also be implemented as a portable device such as a laptop computer 50 (or handheld computer); a cellular telephone 52 with a micro or embedded Web Browser; a Portable Digital Assistant 54 (PDA) capable of wireless network access; a pen-based or tablet computer 56. In another embodiment, the user device 14 can be a cable box 60 or other similar device for viewing through a display 62 or television. Current embodiments of computer system 10 can also be modified to use any of these or future developed devices.

The computer system 10 is designed in this way as to provide flexibility in its deployment. Depending upon the requirements of the particular embodiment, the Engine could be designed to work in any environment such as a desktop application, a web application, or even simply as a series of web services designed to communicate with an external application.

The hardware and system software are designed with two key concerns; flexibility and scalability. Although some specifics for software and hardware components may be mentioned herein, it will be understood that a wide array of different components could be substituted, such as using different database vendors or even replacing the databases with XML-based document stores.

When the computer system 10 is used to execute the logic of the processes described herein, such computer(s) and/or execution can be conducted at a same geographic location or multiple different geographic locations. Furthermore, the execution of the logic can be conducted continuously or at multiple discrete times.

The computer system 10 includes a computer readable medium storing instructions for allowing operated property asset analysis. The instructions for allowing operated asset analysis may run on any system; such as, but not limited to, the user devices 14 or the host system 12. The operating entity of the asset is preferably able to view the asset status as if the operating entity had traveled to the asset. For example, an operating entity would be able to view photos of operated property, continuous surveillance (video surveillance or the like), equipment inventory, pictures, and comparison of the status of an operated property in relation to governmental regulations, and the like.

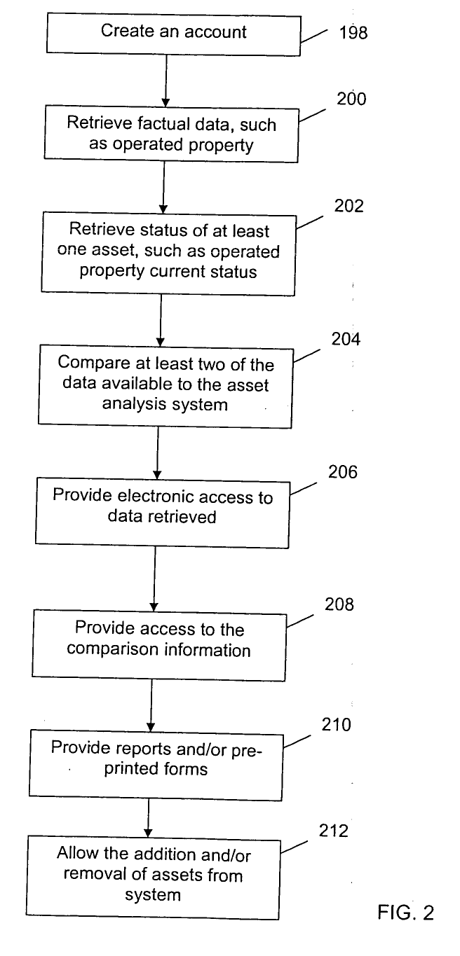

Shown in FIG. 2 is an example of a process of the asset analysis system. The first step 198 is to create an account. The account preferably includes information related to the operating entity, operated property, and maybe the user information. The account is preferably used to create a web service capability between the operating entities, third parties, users, and/or administrative personnel. In addition, administrative personnel may use such web services to allow communications amongst personnel at the asset location and in house personnel. The next step 200 is to retrieve factual data. The factual data could be any data inputted directly into the asset analysis system, extracted from another system or device, or any other way that would make such information available for the asset analysis system. In the example of the operated property asset analysis system, such data would be regulation data, historic data, map data, or the like. The second step 202 is preferably to retrieve status of at least one asset. Similarly, the status could be inputted directly into the asset analysis system, extracted from another system or device, or any other way that would make such information available for the asset analysis system. It should be noted that in the preferred embodiment, steps 202 can precede step 200.

The third step 204 is to compare at least two of the data available to the asset analysis system. The fourth step 206 is to provide electronic access to the data inputted; whereas the fifth step 208 is to provide access to the comparison information. It should be noted that access may be available prior to the retrieval of the data; on the other hand, such data can not be viewed until it is available to the asset analysis system.

The sixth step 210 is to provide reports and/or pre-populated forms that preferably contain at least one of the retrieved data and/or at least one of the analyzed data. It should be noted that the system may also have the ability of restricting and allowing the printing of any output generated by the asset analysis system. The seventh step 212 is to allow the addition and/or removal of assets from the system. In the preferred embodiment, the removal and/or addition of assets can be done at any time, before, during, or after any of the above steps.

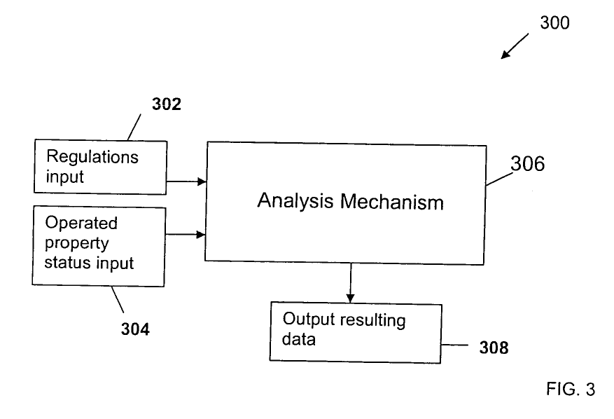

As shown in FIG. 3, the asset analysis can preferably accept at least one input and at least one output. In the example shown in FIG. 3, an operated property asset analysis system 300 is shown. In the preferred embodiment, the operated property asset analysis system 300 has the functionality of providing information to the operating entity as if the operating entity has personally traveled to the operated property site. In addition, the operated property analysis system 300 preferably is able to retrieve inputs from experts such as field inspectors, government agency, and the like in order to provide expert analysis to the operating entities.

The operated property asset analysis 300 accepts regulation input 302 and operated property status input 304. The regulation input 302 can be retrieved from another system or manually inputted into the operated property asset analysis system 300. In the preferred embodiment, the regulations input 302 may be automatically retrieved from official agencies or governmental institution. Similarly, the operated property status 304 may be retrieved from another system or manually inputted into the operated property asset analysis system 300.

The operated property asset analysis system 300 may include an analysis mechanism 306. The analysis device 306 preferably contains computer instructions that run on a system 12 and communicates with network 16 as shown in FIG. 1. The analysis mechanism 306 is preferably able to receive at least one input, such as regulations or well data, and preferably can output at least one output, such as a report or pre-populated form. In the example shown in FIG. 3, the analysis mechanism 306 is able to receive at least regulation input 302 and operated property status 304 inputs. The analysis mechanism 306 may then analyze assets of the operated property and compare the asset of the current operated property to other inputs such as regulation, past inspections, historic production, other operated properties and the like. The analysis mechanism 306 preferably is able to keep track of inventory, images of operated properties, and the like.

The analysis mechanism may output resulting data 308 that are preferably accessible by the operating entities. In the preferred embodiment, the operating entities are capable of accessing the resulting records via the internet, remote computers, terminals, or the like. The output resulting data 308 preferably reside on a system 12 as shown in FIG. 1. The output resulting data 308 may be, but are not limited to, pre-populated governmental forms, inventory reports, profit analysis, oil production, and the like.

In should be noted, that the operated property asset analysis system 300 may also be used for scheduling inspections, maintaining scheduling of inspections and maintenance, and/or directing inspectors. In such use, the operated property asset analysis systems 300 is preferably capable of producing maps and/or connect to a GPS capable system to direct inspectors of well locations.

Although the foregoing invention has been described in some detail by way of illustration and example for purposes of clarity of understanding, it will be obvious to those skilled in the art that certain changes and modifications may be practiced without departing from the spirit and scope thereof, as described in this specification and as defined in the appended claims below.

What is claimed is:

1. An operated property analysis sequence of instructions stored on at least one computer readable medium for running on a computer system, comprising:
instructions for receiving factual data;
instructions for receiving operated property status;
instructions for comparing the factual data to the operated property status; and
instructions for allowing an operating entity to view data and analysis over the Internet as if viewing operated property at the location of the operated property.

2. The operated property analysis sequence of instructions stored on the computer readable medium of claim 1 further comprising instructions for allowing the operating entity to print at least one set of data or analysis.

3. The operated property analysis sequence of instructions stored on the computer readable medium of claim 1 further comprising instructions for disallowing the operating entity to print at least one set of data or analysis.

4. The operated property analysis sequence of instructions stored on the computer readable medium of claim 1 further comprising instructions for allowing the operating entity to print at least one pre-filled standard form.

5. The operated property analysis sequence of instructions stored on the computer readable medium of claim 1 further comprising instructions for allowing a third party to view a location of at least one operated property.

6. The operated property analysis sequence of instructions stored on the computer readable medium of claim 5 further comprising instructions for allowing a third party to print a map of the location of at least one operated property.

7. The operated property analysis sequence of instructions stored on the computer readable medium of claim 5, wherein the location of the at least one operated property is displayed on an interactive system.

8. The operated property analysis sequence of instructions stored on the computer readable medium of claim 1 further comprising instructions for allowing the scheduling of third party inspection to at least one operated property.

9. The operated property analysis sequence of instructions stored on the computer readable medium of claim 1 further comprising instructions for allowing the operating entity to display at least one historic operated property's information.

10. The operated property analysis sequence of instructions stored on the computer readable medium of claim 9 further comprising instructions for allowing the operating entity to compare at least one historic operated property data or analysis to the operated property analysis.

11. The operated property analysis sequence of instructions stored on the computer readable medium of claim 9 further comprising instructions for allowing the operating entity to compare at least two historic operated property data or analysis.

12. The sequence of instructions stored on the computer readable medium of claim 1, wherein the computer system is a distributed computer system.

13. The sequence of instructions stored on the computer readable medium of claim 1, wherein the computer system is a stand alone device.

14. The sequence of instructions stored on the computer readable medium of claim 1, wherein the factual data is governmental regulation.

15. The sequence of instructions stored on the computer readable medium of claim 14, wherein the governmental regulation is retrieved from a remote location over the Internet.

16. The sequence of instructions stored on the computer readable medium of claim 1, wherein the operated property status includes at least one image of the operated property.

17. The sequence of instructions stored on the computer readable medium of claim 16, wherein the at least one image is a 360 degrees image of the operated property.

18. The sequence of instructions stored on the computer readable medium of claim 1, wherein the operated property status includes equipment inventory of at least one operated property.

19. The sequence of instructions stored on the computer readable medium of claim 1, wherein the operated property status includes inspection information of at least one operated property.

20. The sequence of instructions stored on the computer readable medium of claim 1, wherein the operated property status includes environmental information of at least one operated property.

21. The sequence of instructions stored on the computer readable medium of claim 1 further comprising instructions for allowing the removal and addition of at least one operated property to be analyzed.

22. The sequence of instructions stored on the computer readable medium of claim 1 further comprising instructions for allowing at least one mode of access.

23. The sequence of instructions stored on the computer readable medium of claim 22, where the mode of access is a user mode access.

24. The sequence of instructions stored on the computer readable medium of claim 22, wherein the mode of access is an administrative mode access.

25. The sequence of instructions stored on the computer readable medium of claim 22, wherein the mode of access is a user mode access and an administrative mode access that controls the user mode access.

26. The sequence of instructions stored on the computer readable medium of claim 1, wherein the operated property is an operated oil well property.

27. The sequence of instructions stored on the computer readable medium of claim 1, wherein the operated property is an operated gas well property.

28. The sequence of instructions stored on the computer readable medium of claim 1, wherein the operated property is an operated injection well property.

29. The sequence of instructions stored on the computer readable medium of claim 1, wherein the operated property is an operated salt water supply well property.

30. A method of using a sequence of instructions for performing operated property analysis, comprising:
retrieving factual data;
retrieving operated property status; and
providing an operating entity the ability to view data and analysis over the Internet as if viewing the operated property at the location of the operated property.

31. A method for configuring a computer system for performing operated property analysis, comprising the step of:
making a set of instructions on a computer readable medium accessible to a processor of a computer system, the set of instructions including instructions for:
retrieving factual data;
retrieving operated property status; and
providing an operating entity the ability to view data and analysis over
the Internet as if viewing the operated property at the location of the operated property.

32. A method for enhancing operated property analysis, comprising the step of:
selling and distributing a set of instructions for:
retrieving factual data;
retrieving operated property status; and
providing an operating entity the ability to view data and analysis over
the Internet as if viewing the operated property at the location of
the operated property.

33. A method for configuring a computer system, comprising the step of:
providing access to a set of instructions stored on a computer readable medium for installation on a computer readable medium associated with the computer system, the set of instructions including instructions for:
retrieving factual data;
retrieving operated property status; and
providing an operating entity the ability to view data and analysis over
the Internet as if viewing the operated property at the location of the operated property.
